(19) United States
(12) Patent Application Publication
(10) Pub. No.: US 2010/0130184 A1
(43) Pub. Date: May 27, 2010

(54) HAND-HELD DEVICE FOR ADAPTING A NOTICING TIME BASED ON WEATHER FORECAST AND METHOD THEREOF

(76) Inventors: Cros FAN, Nanjing City (CN); Xia Sun, Nanjing City (CN)

Correspondence Address: Muncy, Geissler, Olds & Lowe, PLLC, 4000 Legato Road, Suite 310, FAIRFAX, VA, 22033, US

(21) Appl. No.: 12/625,330

(22) Filed: Nov. 24, 2009

(30) Foreign Application Priority Data
Nov. 25, 2008 (TW) 097145530

(51) Int. Cl. H04L 29/06

(52) U.S. Cl. 455/414.3

(57) ABSTRACT

A hand-held device for adapting a time at which to give notice to a user based on a weather forecast and a method thereof are provided, which includes a forecast receiving module connected to a weather forecast station for periodically obtaining the weather forecast, a time adapting module for adapting the noticing time, a parameter setting module for inputting a location weather-type and noticing time adaptation parameter, the location weather-type and noticing time adaptation parameter including a location and adaptation settings corresponding to the location, wherein each of the adaptation settings specifies how to adapt the noticing time according to a weather type, and a matching module for matching the weather forecast in the adaptation settings of the weather-type and noticing time adaptation parameter. The time adapting module is used for adapting the noticing time according to at least one of the adaptation settings corresponding to the weather forecast.

This application claims the benefit of Taiwan Patent Application No. 097145530, filed on Nov. 25, 2008, which is hereby incorporated by reference for all purposes as if fully set forth herein.

### BACKGROUND OF THE INVENTION

### 1. Field of the Invention

The present invention relates to a hand-held device having a function to adapting a time at which to give notice (hereinafter referred to as a noticing time) to a user and a method thereof, and more particularly to the hand-held device which adapts a noticing time according to weather forecast and the method thereof.

2. Description of the Prior Art

In prior art, cell phones are built in with an alarm module which provides users to set a time for alarm, such that the alarm module will alarm the user according to the setting time. By this method, the user can set alarm time according to his/her schedule, so as to allow the cell phone to send a sound or notice a voice at the setting time for alarming user to follow the schedule.

However, the prior art has shown an unavoidable shortcoming, that is, the alarm module of the conventional cell phone does not take into account a factor of weather conditions. The weather conditions may be very likely to force the user to change his or her schedule, yet the alarm module of the conventional cell phone can only send out a sound or notice a voice in the specific time set by the user and cannot automatically adapts the alarm time depending upon a habit or user's requirement. As a result, for the users who need to often change the schedule according to the weather conditions, the practicability of this kind of alarm module is relatively lower.

### SUMMARY OF THE INVENTION

Accordingly, the present invention is directly to provide a hand-held device which can be aware of the weather conditions from a received weather forecast and adapt a noticing time to a user according to the weather forecast, and a method thereof.

The technical means provided by the present invention discloses a method by which a hand-held device adapts a noticing time according to a weather forecast, wherein a time adapting module is utilized to set a noticing time; then a weather-type and noticing time adaptation parameter including a location and plural adaptation settings corresponding to the location is inputted into a parameter setting module; and a matching module is determined whether it is turning on. If the matching module has been turning on, then whether a weather forecast data has been obtained in advance is determined. And if the weather forecast has been obtained, then the weather forecast is matched in the adaptation settings of the weather-type and noticing time adaptation parameter, and the noticing time is adapted according to at least one of the adaptation settings corresponding to the weather forecast.

The technical means provided by the present invention discloses a hand-held device for adapting a noticing time based on a weather forecast. The hand-held device includes a forecast receiving module, a time adapting module, a parameter setting module and a matching module.

The forecast receiving module is connected to a weather forecast station to obtain a weather forecast. The time adapting module provides the user to set a noticing time. The parameter setting module is used for setting up a weather-type and noticing time adaptation parameter which includes a location and corresponding adaptation settings. Then the weather forecast is matched in the adaptation settings of the weather-type and noticing time adaptation parameter, and the noticing time can be adapted according to at least one of the adaptation settings corresponding to the weather forecast by the matching module.

The present invention is provided with functions that the prior art is unable to achieve, that is, the weather-type and noticing time adaptation parameter is set up by the user, with a different setting corresponding to a different weather condition, the user will definitely take an action to change the schedule, such that the time at which to give notice can be adapted automatically according to the conditions of the weather forecast. Therefore, the user is provided with a more humanized function that ringtone, voice or alarm sound can be applied more flexibly according to the weather data.

To enable a further understanding of the said objectives and the technological methods of the invention herein, the brief description of the drawings below is followed by the detailed description of the preferred embodiments.

### BRIEF DESCRIPTION OF THE DRAWINGS

The present invention will become more fully understood from the detailed description given herein below and the accompanying drawings which are given by way of illustration only, and thus are not limitative of the present invention, and wherein.

FIG. 1 shows a block diagram of structure of a hand-held device of an embodiment of the present invention.

FIG. 2 shows a flow chart of a first embodiment of adapting a noticing time, according to the present invention.

FIG. 3 shows a diagram of setting up a noticing time of an embodiment of the present invention.

FIG. 4 shows a diagram of setting up a weather-type and noticing time adaptation parameter of an embodiment of the present invention.

FIG. 5 shows a diagram of an interface for selecting a weather forecast station of an embodiment of the present invention.

FIG. 6 shows a flow chart of a second embodiment of adapting a noticing time according to the present invention.

FIG. 7 shows a flow chart of a third embodiment of adapting a noticing time according to the present invention.

FIG. 8 shows of a diagram of setting up a check time and a noticing time of a third embodiment according to the present invention.

### DETAILED DESCRIPTION OF THE PREFERRED EMBODIMENTS

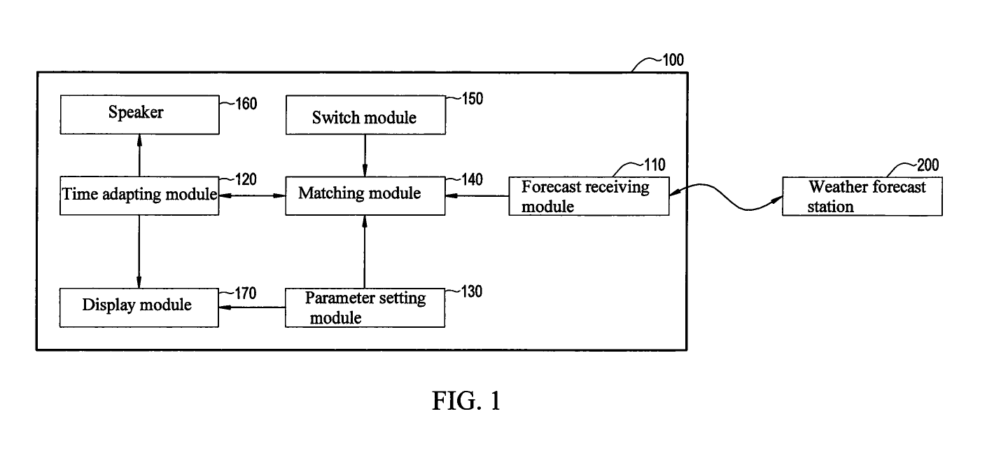

Referring to FIG. 1, it shows a block diagram of structure of a hand-held device of an embodiment of the present invention. The hand-held device 100 comprises a forecast receiving module 110, a time adapting module 120, a parameter setting module 130, a matching module 140, a switch module 150, a speaker 160 and a display module 170.

The forecast receiving module 110 is connected to a weather forecast station 200 for periodically obtaining a weather forecast. The weather forecast station 200 provides weather information in a standard format and the forecast receiving module 110 categorizes and stores the weather data of each location contained in the weather information, according to a default categorization method to form the weather forecast. The time adapting module 120 allows a user to adapt a noticing time according to his or her schedule. The parameter setting module 130 provides the user to input a local weather-type and noticing time adaptation parameter which includes a location and plural adaptation settings corresponding to the location, and each of the adaptation settings specifies how to adapt the noticing time according to a weather type. The matching module 140 matches the weather forecast in the adaptation settings of the weather-type and noticing time adaptation parameter, The time adapting module can adapt the noticing time according to at least one of the adaptation settings corresponding to the weather forecast. When the time adapting module 120 determines that a current time reaches the adapted noticing time, sound to give notice is output by the speaker 160. The sound may include current weather broadcasting sound for broadcasting the weather forecast corresponding to the adapted noticing time Furthermore, the display module 170 may display a notice such as a noticing time or a notice of weather.

The switch module 150 switches between turning on and turning off the matching module 140 according to a switch instruction, the time adapting module 120 adapts the noticing time according to a time adaptation instruction, and the parameter setting module 130 inputs or updates the local weather-type and noticing time adaptation parameter according to a parameter setting instruction.

In addition to displaying the notice, the display module 170 also displays related pictures including the weather forecast data, the noticing time, the weather-type and noticing time adaptation parameter, as well as the activation and deactivation of the matching module 140.

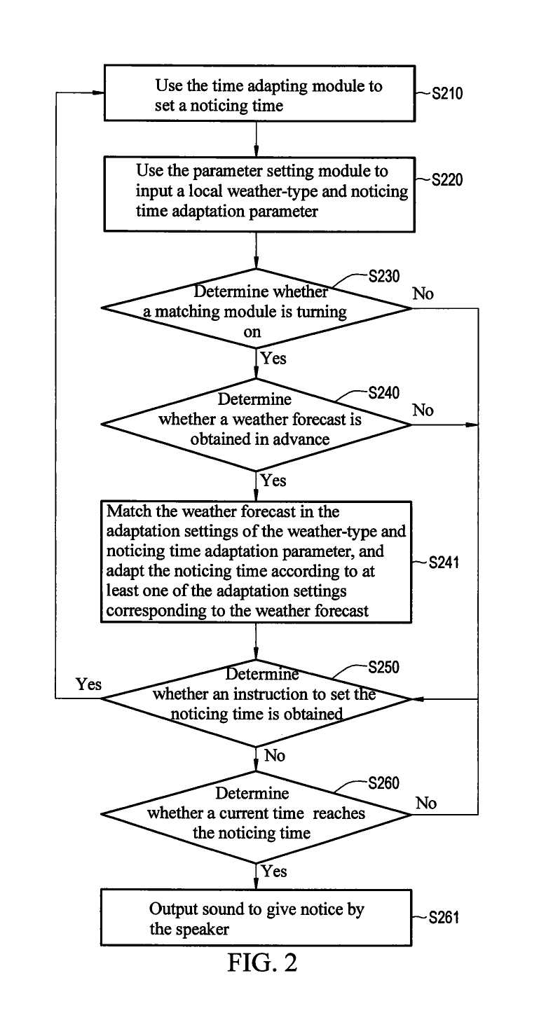

Referring to FIG. 2, it shows a flow chart of a first embodiment of adapting a noticing time according to the present invention, with reference to FIG. 1 at the same time to help understanding. This method of adapting the noticing time according to a weather forecast comprises following steps.

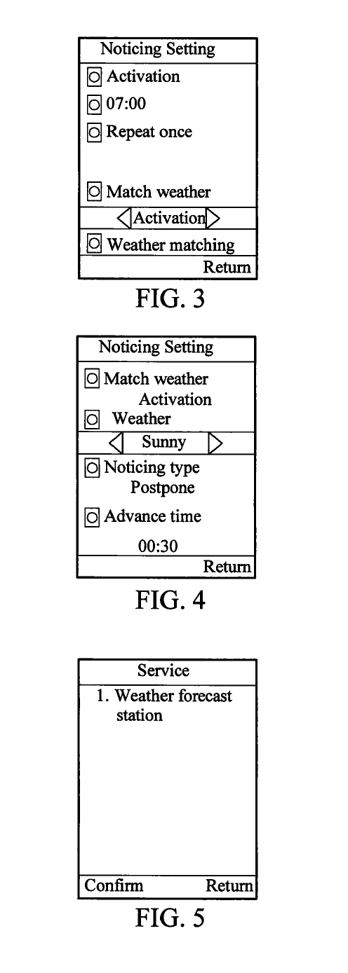

The time adapting module 120 is used to set a noticing time (step S210). As required, the user uses the time adapting module 120 to set or adapt a noticing time in association with a schedule. As shown in FIG. 3, the display module 170 displays that the noticing time set by the time adapting module 120 is 7:00 AM.

The parameter setting module 130 is used to input a local weather-type and noticing time adaptation parameter (step S220). As shown in FIG. 3, the user can use an operating interface provided by the hand-held device 100 to issue a parameter setting instruction to input or update a local weather-type and noticing time adaptation parameter which includes a location and plural adaptation settings corresponding to the location. The location is a geographical location designated by the user, such as New York City, Detroit City or Salt Lake City, etc, and each of the adaptation settings specifies how to adapt the noticing time according to a weather type, such as postponing by 30 minutes in Sunny day, advancing by 60 minutes (or 1 hour) in Rainy day, advancing by 30 minutes in Cloudy day or postponing by 60 minutes in Snowing day. As shown in FIG. 4, the weather is a sunny day, the noticing type is “postpone” and the noticing time is 30 minutes in advance, meaning that when the weather of the location designated by the user is sunny, the noticing time is postponed by 30 minutes to notice the user (or sending out a sound, a ringtone, etc.).

It is determined whether the matching module 140 has been turning on (step S230). This step is to primarily determine whether to perform a weather matching operation. If it is determined that the matching module 140 has been turning on, then whether a weather forecast has been obtained in advance is determined (step S240). As shown in FIG. 3, the user can shift a field of “Match weather” by a function key to activate or deactivate the matching module 140.

Referring to FIG. 5, the forecast receiving module 110 receives weather information from the weather forecast station 200 and categorizes and constructs the weather information into the weather forecast data. This method is described below.

Whether a daily weather forecast report, which is the current day's weather forecast, has been obtained is determined. If it is determined that the daily weather forecast report has been obtained, then the weather forecast from the location and a weather data of the location which are derived from the daily weather forecast report is obtained by the forecast receiving module 110.

On the contrary, if it is determined that the daily weather forecast report has not been obtained, then whether a weekly weather forecast report has been obtained is determined. The weekly weather forecast report refers to the weather change at each day of each location in a week. If it is determined that the weekly weather forecast report has been obtained, then the weather forecast from a date, the location and a weather data of the location at the date which are derived from the weekly weather forecast report is obtained by the forecast receiving module 110.

On the other hand, if the weekly weather forecast report has not been obtained, then whether the daily weather forecast report has been obtained is determined again. These steps are repeatedly executed, until either the daily weather forecast report or the weekly weather forecast report is obtained.

If it is determined that the weather forecast has been obtained, the weather forecast is matched in the adaptation settings of the weather-type and noticing time adaptation parameter, and the noticing time is adapted according to at least one of the adaptation settings corresponding to the weather forecast (step S241). As described above, the weather forecast is matched in the adaptation settings of the weather-type and noticing time adaptation parameter by the matching module 140, and according to at least one of the adaptation settings corresponding to the weather forecast, the noticing time can be adapted by the time adapting module 120. In addition, there are three adaptation operations of the time adapting module 120. One is to adapt the noticing time to advance a schedule by a specific period, the second one is to adapt the noticing time to postpone a schedule by a specific period and the third one is not to change the noticing time. As shown in FIG. 4, if the location is New York city and the current weather of New York city in the weather forecast data is Sunny, then the noticing time is adapted from 7:00 o'clock to 7:30 according to the adaptation settings of Sunny day.

After that, whether an instruction to set the noticing time is obtained is determined (step S250). This instruction can be a switch instruction, a parameter setting instruction, a time adaptation instruction or a combination of more than two instructions among the aforementioned three kinds of instructions. The switch module 150 switches between turning on and turning off the matching module 140 according to the switch instruction, the parameter setting module 130 updates the weather-type and noticing time adaptation parameter according to the parameter setting instruction and the time adapting module 120 adapts the noticing time according to the time adaptation instruction.

If the hand-held device 100 determines that the instruction has been obtained, proceeding to the step of setting the noticing time by the time adapting module 120 (step S210). This step is to set an updating operation as required, before achieving the noticing time. As shown in FIG. 3 and FIG. 4, when the user inputs any one instruction through the operating interface of the hand-held device 100, the hand-held device 100 will record all the parameters again to update the related settings and determine whether the matching module 140 has been switched.

If the hand-held device 100 determines that the instruction has been not obtained, then whether a current time reaches the noticing time is determined (step S260). If it is determined that the current time reaches the noticing time, then sound to give notice is outputted by the speaker 160 (step S261), or a related noticing voice is sent out when a voice noticing function is activated. For example, the noticing sound may include current weather broadcasting to broadcast the weather forecast corresponding to the adapted noticing sound. However, if it is determined that the current time does not reach the noticing time, then proceeding to the step of determining whether the instruction is obtained. This is primarily to broadcast the weather forecast data matched to the noticing time, allowing the user to be aware of the current time or the current day's weather, so as to facilitate adapting the current day's schedule. Moreover, the notice can be displayed by the display module 170 and this notice is built into the hand-held device 100 or is configured at a same time when the user is inputting the weather-type and noticing time adaptation parameter.

Besides, when the hand-held device 100 determines that the matching module 140 has not been turning on and determines that the weather forecast data has not been obtained, whether an instruction has been obtained will be determined (step S250). When the user uses the switch module 150 to turning off the matching module 140, it is definitely that there is no need to match the weather forecast in the adaptation settings of the weather-type and noticing time adaptation parameter; thus, the hand-held device 100 only executes the alarm or noticing function like the prior art. On the other hand, when it is determined that the weather forecast has not been obtained, it is definitely that the hand-held device 100 has not obtained the related weather forecast, including the daily weather forecast report and the weekly weather forecast report, in a long time. Therefore, the forecast receiving module 110 is unable to obtain and establish the required weather forecast data, and the matching module 140 cannot match the weather forecast but can only execute the ordinary alarm function.

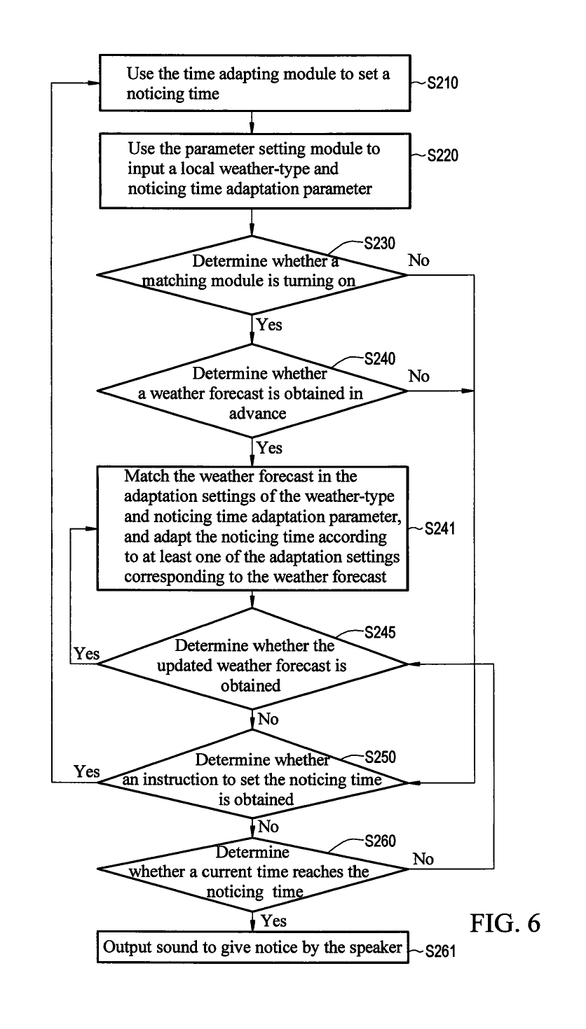

Referring to FIG. 6, it shows a flow chart of a second embodiment of adapting a noticing time according to the present invention, with reference to FIG. 1 and FIG. 2 at a same time to help understanding. A different between the second embodiment and the first embodiment is that after step S241 and before step S250, it further includes an updated weather forecast, as described below.

It is determined whether the updated weather forecast has been obtained (step S245). As described above, the forecast receiving module 110 periodically obtains the weather forecast from the weather forecast station 200, including that:

1. The forecast receiving module 110 is actively connected to the weather forecast station 200 at a fixed time to download and obtain the weather forecast.

2. The weather forecast station 200 actively and periodically transmits the weather forecast to the forecast receiving module 110 which receives the weather forecast passively.

Disregarding the conditions above, as long as the forecast receiving module 110 has obtained the updated weather forecast, proceeding to step S241, allowing the matching module 140 to match the weather forecast in the adaptation settings of the weather-type and noticing time adaptation parameter, and the time adapting module 120 to adapt a new noticing time according to at least one of the adaptation settings corresponding to the weather forecast.

On the contrary, when the forecast receiving module 100 has not obtained any updated weather forecast, the step S250 will be executed and the hand-held device 100 will determine whether any instruction has been obtained.

At this time, if the hand-held device 100 determines that no instruction is obtained and determines that the current time is not the noticing time, then proceeding to the step 5245. These execution steps are repeated cyclically, achieving that whether the updated weather forecast has been obtained is determined in a real time, such that the noticing time can be adapted immediately based upon the change of weather forecast before the noticing time.

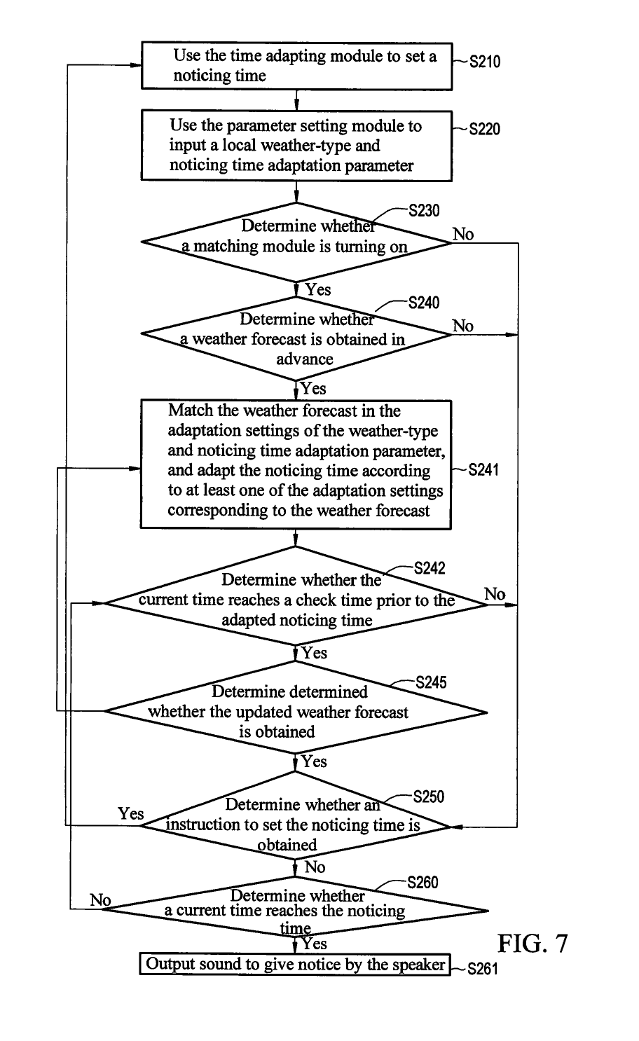

Referring to FIG. 7, it shows a flow chart of a third embodiment of adapting a noticing time according to the present invention, with reference to FIGS. 1, 6 and 8 at a same time to help understanding. A difference between the third embodiment and the second embodiment is that after step S241 and before step S250, the forecast receiving module 110 will first determine whether the current time reaches a check time prior to the adapted noticing time (step S242).

The check time is set by the matching module 140 at a same time when the time adapting module 120 adapts the noticing time based upon the adaptation settings. In addition, the check time is earlier than a time point after the noticing time is adapted through each adaptation setting. Besides, the forecast receiving module can obtain the updated weather forecast at the check time to allow the matching module 140 to match the updated weather forecast in the adaptation settings of the weather-type and noticing time adaptation parameter.

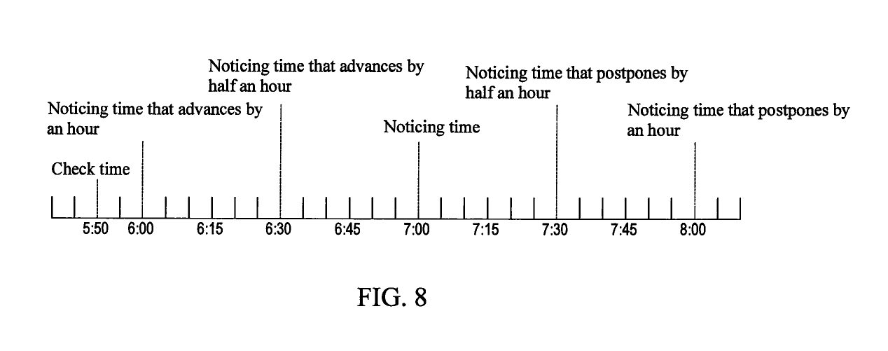

Referring to FIG. 8, if the default noticing time is 7:00 AM and the specific times corresponding to each adaptation setting include advancing by half an hour (30 minutes), advancing by an hour (60 minutes), postponing by half an hour (30 minutes) and postponing by an hour (60 minutes), then after adapting the noticing time through the time adapting module 120, the possible noticing time will include (1) the noticing time that advances by one hour, or 6:00 PM sharp (2) the noticing time that advances by half an hour, or 6:30 AM (3) the default noticing time, or 7:00 AM sharp (4) the noticing time that postpones by half an hour, or 7:30 AM or (5) the noticing time that postpones by one hour, or 8:00 AM. Therefore, the check time must be before 6:00 AM, such as 5:50 AM.

As a result, the adaptation of time adapting module 120 can be that:

1. A time interval is set up to compute the possible noticing time and this time interval is computed forward starting from the earliest noticing time to serve as the check time. As described above, the earliest noticing time is 6:00 AM, the time interval is 10 minutes, and therefore, the check time will be 5:50 AM.

2. Time adaptation units for adapting the noticing time are determined, and a value which exceeds the largest time adaptation unit is used as the adaptation value to compute forward the check time based on the noticing time. For example, the noticing time is 7:00 AM, the largest time adaptation unit is advancing by 60 minutes, and hence, the adaptation value is adapted as a value more than 60 minutes. Accordingly, the check time will be 70 minutes before 7:00 AM, which is 5:50 AM.

If the forecast receiving module 110 determines that the current time reaches the check time, whether an updated weather forecast and is determined. If it is determined that the update weather forecast is not obtained by the forecast receiving module 110, whether the current time reaches the adapted noticing time is then determined. And if it is determined that the current time reaches the adapted noticing time, then sound to give the notice is output by the speaker 160. The detail descriptions are disclosed as below:

First, whether an updated weather forecast is obtained will be determined (step S245).

If the updated weather forecast is obtained, proceeding to the step S241 of the updated weather forecast is matched in the adaptation settings of the weather-type and noticing time adaptation parameter and the noticing time is adapted by the time adapting module 120 according to at least one of the adaptation settings corresponding to the updated weather forecast. If the updated weather forecast is not obtained, then the hand-held device 100 will determine whether an instruction to set the noticing time is obtained. If the hand-held device 100 determines that the instruction has been obtained, proceeding to the step of setting the noticing time by the time adapting module 120. However, if the hand-held device 100 determines that the instruction has been not obtained, then whether a current time reaches the adapted noticing time is determined. And if it is determined that the current time reaches the adapted noticing time, then sound to give notice is outputted by the speaker 160

When the forecast receiving module 110 determines that the current time is not the check time or the hand-held device 100 does not obtain the updated weather forecast at the check time, then proceeding to step S250, allowing the hand-held device 100 to determine whether the instruction has been obtained to decide whether to proceed the step S210 to re-adapt the noticing time.

However, another difference between the third embodiment and the first embodiment or the second embodiment is that when the time adapting module 120 determines that the current time is not the noticing time, then proceeding to the step S242, in order to check in real time whether the check time has been achieved.

Combining the aforementioned steps, a multiple-layer periodical cycle is formed. Prior to the noticing time, the user can input freely the instruction and when the check time is on, the weather forecast is updated to assure accuracy of the weather forecast and to adapt the noticing time properly, thereby facilitating the user to plan the schedule.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method for adapting a time at which to give notice to a user of a handheld device based on a weather forecast, comprising:
setting the noticing time;
inputting a location weather-type and noticing time adaptation parameter including a location and adaptation settings corresponding to the location, wherein each of the adaptation settings specifies how to adapt the noticing time according to a weather type;
determining whether a weather forecast of the location is obtained; and
if it's determined that the weather forecast is obtained, matching the weather forecast in the adaptation settings of the weather-type and noticing time adaptation parameter, and adapting the noticing time according to at least one of the adaptation settings corresponding to the weather forecast.

2. The method according to claim 1, further comprising:
determining whether an instruction to set the noticing time is obtained;
if it's determined that the instruction is obtained, proceeding to the step of setting the noticing time;
if it's determined that the instruction is not obtained, determining whether a current time reaches the noticing time; and
if it's determined that the current time reaches the noticing time, then outputting sound to give the notice; and

3. The method according to claim 2, wherein the noticing sound includes sound of current weather broadcasting, for broadcasting the weather forecast corresponding to the adapted noticing time.

4. The method according to claim 1, wherein after the step of matching the weather forecast in the adaptation settings of the weather-type and noticing time adaptation parameter and adapting the noticing time, the method further comprising:
determining whether a current time reaches a check time prior to the adapted noticing time;
if it's determined that the current time reaches the check time, determining whether an updated weather forecast is obtained; and
if it's determined that the updated weather forecast is obtained, proceeding to the step of matching the updated weather forecast in the adaptation settings of the weather-type and noticing time adaptation parameter and adapting the noticing time according to at least one of the adaptation settings corresponding to the updated weather forecast.

5. The method according to claim 4, further comprising:
if it's determined that the updated weather forecast is not obtained, determining whether an instruction to set the noticing time is obtained;
if it's determined that the instruction is obtained, proceeding to the step of setting the noticing time;
if it's determined that the instruction is not obtained, determining whether the current time reaches the adapted noticing time; and
if it's determined that the current time reaches the adapted noticing time, then outputting sound to give the notice.

6. The method according to claim 1, wherein after the step of matching the weather forecast in the adaptation settings of the weather-type and noticing time adaptation parameter and adapting the noticing time, the method further comprises:
determining whether an updated weather forecast is obtained;
if it's determined that the updated weather forecast is obtained, proceeding to the step of matching the updated weather forecast in the adaptation settings of weather-type and noticing time adaptation parameter and adapting the noticing time according to at least one of the adaptation settings corresponding to the updated weather forecast;
if it's determined that the updated weather forecast is not obtained, determining whether an instruction to set the noticing time is obtained; and
if it's determined that the instruction is obtained, proceeding to the step of setting the noticing time.

7. The method according to claim 6, further comprising:
if it's determined that the instruction is not obtained, determining whether a current time reaches the adapted noticing time; and
if it's determined that the current time reaches the adapted noticing time, then outputting sound to give the notice.

8. The method according to claim 1, wherein before the step of determining whether a weather forecast is obtained, the method further comprises:
determining whether a daily weather forecast report is obtained;
if it's determined that the daily weather forecast report is obtained, obtaining the weather forecast from the location and a weather data of the location which are derived from the daily weather forecast report;
if it's determined that the daily weather forecast report is not obtained, then determining whether a weekly weather forecast repost is obtained; and
if it's determined that the weekly weather forecast report is obtained, obtaining the weather forecast from a date, the location and a weather data of the location at the date which are derived from the weekly weather forecast report.

9. The method according to claim 1, wherein the step of adapting the noticing time according to at least one of the adaptation settings corresponding to the weather forecast comprises advancing the noticing time by a specific period.

10. The method according to claim 1, wherein the step of adapting the noticing time according to at least one of the adaptation settings corresponding to the weather forecast comprises postponing the noticing time by a specific period.

11. A hand-held device for adapting a time at which to give notice to a user based on a weather forecast, comprising:
a forecast receiving module connected to a weather forecast station for periodically obtaining the weather forecast;
a time adapting module for adapting the noticing time;
a parameter setting module for inputting a location weather-type and noticing time adaptation parameter, the location weather-type and noticing time adaptation parameter including a location and adaptation settings corresponding to the location, wherein each of the adaptation settings specifies how to adapt the noticing time according to a weather type; and
a matching module for matching the weather forecast in the adaptation settings of the weather-type and noticing time adaptation parameter.
wherein the time adapting module is used for adapting the noticing time according to at least one of the adaptation settings corresponding to the weather forecast.

12. The hand-held device according to claim 11, further including a switch module for switching between turning on and turning off the matching module based upon a switch instruction input from outside.

13. The hand-held device according to claim 11, further including a speaker, wherein when the time adapting module determines that a current time reaches the adapted noticing time, sound to give the notice is outputted by the speaker.

14. The hand-held device according to claim 13, wherein the noticing sound includes current weather broadcasting sound for broadcasting the weather forecast corresponding to the adapted noticing time.

15. The hand-held device according to claim 11, wherein adapting the noticing time according to at least one of the adaptation settings corresponding to the weather forecast comprises advancing the noticing time by a specific period.

16. The hand-held device according to claim 11, wherein adapting the noticing time according to at least one of the adaptation settings corresponding to the weather forecast comprises postponing the noticing time by a specific period.

17. The hand-held device according to claim 11, wherein the matching module further sets a check time and the forecast receiving module obtains the updated weather forecast at the check time to allow the matching module to match the updated weather forecast in the adaptation settings of the weather-type and noticing time adaptation parameter.

18. The hand-held device according to claim 11, wherein the weather forecast derives from a daily weather forecast report and the forecast receiving module obtains the weather forecast from the location and a weather data of the location which are derived from the daily weather forecast report.

19. The hand-held device according to claim 11, wherein the weather forecast derives from a weekly weather forecast report and the forecast receiving module obtains the weather forecast from a date, the location and a weather data of the location at the date which are derived from the weekly weather forecast report.

20. The hand-held device according to claim 11, further including a display module to display the notice when the time adapting module determines that a current time reaches the adapted noticing time.
